(19) United States
(12) Patent Application Publication
(10) Pub. No.: US 2011/0228633 A1
(43) Pub. Date: Sep. 22, 2011

(54) AGITATOR

(75) Inventor: Paul Thuerwaechter, Sulzberg (DE)

(73) Assignee: Thuerwaechter GmbH & Co. KG, Sulzberg (DE)

(21) Appl. No.: 12/998,773

(22) PCT Filed: Dec. 7, 2009
(86) PCT No.: PCT/IB2009/007924

§ 371 Date: May 31, 2011

(30) Foreign Application Priority Data
Dec. 7, 2008 (DE) 202008015990

(51) Int. Cl. B01F 7/06

(52) U.S. Cl. 366/343

(57) ABSTRACT

An agitator assembly configured for mounting on a container such as a liquid manure or biogas tank. The assembly includes a tube with a closure member, a drive shaft operably connected to a motor and having a propeller attached thereto, and a flange with a seal. The drive shaft and propeller are longitudinally moveable in and out of the container within the tube while maintaining a seal on the tube to prevent the escape of liquids or gasses from the container. The tube can be closed and the drive shaft and propeller removed without having to empty the container.

### FIELD OF THE INVENTION

This invention relates to an agitator that is configured for mounting on a container, such as liquid manure or biogas tanks, with a drive motor and an agitator propeller.

### SUMMARY

An agitator assembly for mounting on a container, such as a liquid manure or biogas tank, with a tube having first and second ends, and a channel therethrough, the first end of the tube being mounted on the container so as to create a passageway through the tube into the container. The assembly also includes a drive shaft operably connected at a first end to a drive motor and a propeller attached thereto at a second end opposite the first end. The drive shaft moves longitudinally through the channel of the tube such that the second end of the drive shaft with the propeller passes through the tube and moves into and out of the container. The assembly also includes a closure member for opening and closing the passageway from the tube into the container. The assembly also includes a flange member that is releasably connected to the second end of the tube. The flange member has an opening therein which allows the drive shaft to pass through it into the tube and into the container. There is a sealing member mounted on the flange member around the opening in the flange member which creates a seal around the drive shaft at the opening in the flange member. Thus an agitator assembly is provided that is at least longitudinally adjustable to different operating conditions.

For instance, when the agitator propeller is not needed, it can be retracted into the tube behind the closure member, and the closure member can be closed to protect the propeller from the contents of the container. Furthermore, the drive shaft and propeller can be removed for maintenance and repair work.

### BRIEF DESCRIPTION OF THE DRAWINGS

FIG. 1 is a side view of an embodiment of an agitator assembly.

FIG. 2 is a side view of an embodiment of an agitator assembly in a closed and retracted position.

FIG. 3 is a side view of an embodiment of an agitator assembly in an open and operating position.

FIG. 4 is a side view of an embodiment of an agitator assembly engaged with a container.

FIG. 5 is a side view of an embodiment of an agitator assembly in an open and operating position.

Before any independent features and embodiments of the invention are explained in detail, it is to be understood that the invention is not limited in its application to the details of the construction and the arrangement of the components set forth in the following description or illustrated in the drawings. The invention is capable of other embodiments and of being practiced or of being carried out in various ways. Also, it is understood that the phraseology and terminology used herein is for the purpose of description and should not be regarded as limiting.

### DETAILED DESCRIPTION

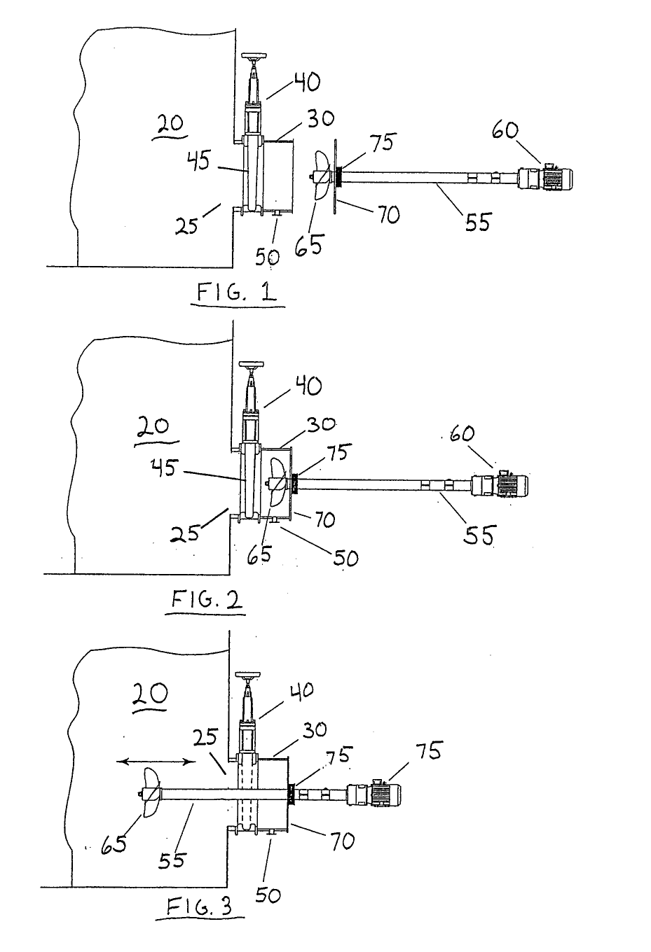

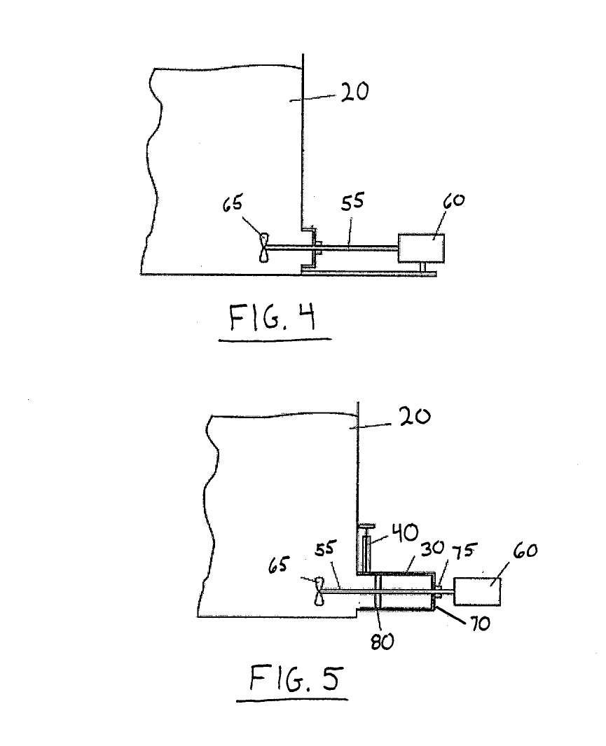

Referring to FIG. 1, an example of an agitator assembly 10 is shown mounted to an exterior of a container 20, such as a liquid manure or biogas tank or the like. A tube 30 is shown connected at one end to the container 20 communicating with the interior of the container 20 and its contents through an opening 25. The tube 30 includes a valve 40 thereon located near the opening of the container 20. In the present example, the valve 40 is a gate valve, but it is contemplated that any type of valve, including a slide valve, can be used, or any other similar mechanism that can close and seal the container 20. Furthermore, in the present example, the valve 40 is located on the tube 30 outside of the container 20, but it is contemplated that the valve 40 can be located inside the container 20, and mounted on the container 20 rather than the tube 30. The valve 40 includes a gate 45 that is moveable during operation of the valve 40 from a first position wherein the gate 45 closes and seals the tube 30, as seen in FIGS. 1 and 2, to a second position wherein the gate 45 is moved out of the path of the tube 30 as depicted by the phantom lines in FIG. 3. The tube 30 also includes a drain 50 therein for allowing fluid contained in the tube to drain out.

A drive shaft 55 is shown connected at one end to a motor 60. A propeller 65 is attached to the second end of the drive shaft 55 opposite the first end. A flange 70 is positioned around the drive shaft 55 between the motor 60 and the propeller 65, and includes a seal 75.

In operation, the drive shaft 55 is moveable longitudinally into the tube 30 as seen in FIGS. 2 and 3. When the propeller 65 at the end of the drive shaft 55 is inside the tube, the flange 70 engages the tube 30 closing the end of the tube 30. The drive shaft 55 remains longitudinally moveable through the flange 70, the seal 75 providing an airtight seal around the drive shaft 55 preventing the escape of gasses or liquids from within the tube 30.

When the valve 40 is open, the drive shaft 55 may be moved longitudinally further into the tube 30, thus projecting the propeller 65 through the open valve 40 into the container 20 as seen in FIG. 3. In this position, the motor 60 can be activated thereby rotating the propeller 65 and agitating or churning the contents of the container 20.

When agitation is not needed, the drive shaft 55 can be moved longitudinally away from the container 20 thereby retracting the propeller 65 into the tube 30 behind the valve 40. Once the propeller 65 is passed the valve 40, the vale 40 can be closed. Once the valve 40 is closed, the flange 70 can be disengaged from the tube 30 and the drive shaft 55 and propeller 65 can be removed for maintenance or cleaning.

In order to achieve higher stability of the guide of the drive shaft 55, it is possible to provide a supporting bearing 80, which, on the one hand, can be moved on the drive shaft 55 and at the same time can be displaced in the tube 30, as seen in FIG. 4.

The foregoing description of the preferred embodiment of the invention has been presented for purposes of illustration and description, and is not intended to be exhaustive or to limit the invention to the precise form disclosed. The descriptions were selected to best explain the principles of the invention and their practical application to enable other skills in the art to best utilize the invention in various embodiments and various modifications as are suited to the particular use contemplated. Although particular constructions of the present invention have been shown and described, other alternative constructions will be apparent to those skilled in the art and are within the intended scope of the present invention. It is intended that the scope of the invention not be limited by the specification, but be defined by the claims set forth below.

What is claimed is:

1. An agitator assembly comprising:
a tube having a first end, a second end and a channel therethrough extending from the first end to the second end, the first end of the tube being configured for mounting on a container so as to create a passageway through the tube into the container;
a drive shaft operably connected at a first end to a drive motor, the drive shaft being adapted to move longitudinally through the channel of the tube such that a second end of the drive shaft having a propeller attached thereto can pass through the tube and move into and out of the container;
a closure member having at least an open position and a closed position, the closure member being adapted to close the passageway from the tube into the container when in the closed position, and open the passageway from the tube into the container when in the open position;
a flange member releasably connected to the second end of the tube, the flange member having an opening therein through which the drive shaft may pass;
a sealing member mounted on the flange member around the opening in the flange member creating a seal around the drive shaft at the opening.

2. The assembly of claim 1, wherein the tube includes a drain for draining liquid contained in the tube.

3. The assembly of claim 1, wherein the tube is mounted on the container near a bottom of the container.

4. The assembly of claim 1, wherein the closure member is a slide valve.

5. The assembly of claim 1, wherein the closure member is located on an exterior of the container.

6. The assembly of claim 1, wherein the closure member is located on an interior of the container.
